(19) United States
(12) Patent Application Publication
(10) Pub. No.: US 2010/0230054 A1
(43) Pub. Date: Sep. 16, 2010

(54) LABEL APPLICATION DEVICE

(76) Inventors: Shinichi Sugawara, Tokyo (JP); Nobuki Seita, Tokyo (JP)

Correspondence Address: OSTROLENK FABER GERB & SOFFEN, 1180 AVENUE OF THE AMERICAS, NEW YORK, NY, 100368403, US

(21) Appl. No.: 12/681,677

(22) PCT Filed: Jun. 23, 2008
(86) PCT No.: PCT/JP2008/061409

§ 371 Date: Apr. 5, 2010

(30) Foreign Application Priority Data
Jul. 30, 2007 (JP) 2007-197454

(51) Int. Cl. B32B 37/02

(52) U.S. Cl. 156/361

(57) ABSTRACT

The object of the present disclosure is to provide a label application device which can easily perform label applying operation by protruding a portion of the label towards an article in a mountain-shape and automatically applying the label, improving the work efficiency by reducing the operation process as much as possible.

The label application device includes: a label holding unit including an attracting board provided with a pair of divided bodies and attracting and holding a label supplied from the label supplying unit; a folding and applying unit folding and protruding a portion of a label held in a mountain-shape forming a folded portion, and applying an outer end portion, provided next to a folded portion to an article; wherein the folding and applying unit including: a movement control unit controlling the movement of the air cylinder unit as a folding unit, wherein the divided bodies and are relatively approaching and separating the other and the label is folded forming the folded portion by the divided bodies pressing the label when the divided bodies approach the other, defining the divided bodies at the separation position when attracting and holding the label, and at a folded portion forming position K by approaching the divided bodies from the separation position.

### TECHNICAL FIELD

The present invention relates to a label application device for applying labels to articles, especially a label application device which folds and protrudes a portion of a label from the back side to the surface side in a mountain-shape (the back side of label urged towards the surface side of the label such that the part of the label portion protrudes to form an oblique angle) and applies the label to an article.

### BACKGROUND ART

A label with a portion of the label folded and protruded from the back side to the surface side in a mountain-shape has been known in the past. Such a label, for example as shown in FIG. 9, is a rectangular-shaped label, which is formed as a folded portion 1 with a portion 2 in the middle part of the label folded and protruded from the back side to the surface side in a mountain-shape and having a first side face 4 and a second side face 5 with an apex portion 3 as a border therebetween, and having each outer end portion 7 provided next to each base end portion of the first side face 4 and the second side face 5 of the folded portions 1 via each bent portion 6. The back sides of the outer end portions 7 are coated with adhesive, and in a planar state, are temporally attached to the backing sheet not shown in the diagram. When applying the label L to an article, the label L is peeled off from the backing sheet and the folded portion 1 is formed by folding label L at the apex portion 3 and at the bent portions 6 by manual labor. Then at the outer end portions 7, the label L is applied to the article (for example, Registered Japanese Utility Model Publication No. 3073917 for reference).

### SUMMARY OF INVENTION

### Technical Problem

Incidentally, with such a label L, since a portion 2 of the label L is protruded to be applied to an article, the work is performed manually, thereby the applying operation becoming complicated.

The present invention has been achieved in view of this problem. Accordingly, it is an object of the present invention to provide a label application device which can protrude a portion of the label in a mountain-shape (the back side of label urged towards the surface side of the label such that the part of the label portion protrudes to form an oblique angle) and automatically applying the label towards an article, thereby facilitating applying operation and improving the work efficiency by reducing the operation process as much as possible.

### Solution to Problem

To solve the above-mentioned problems, the label application device of the present invention includes a label application device applying a label supplied from a label supplying unit comprising: a label holding unit attracting and holding a label supplied from the label supplying unit; and a folding and applying unit folding and protruding a portion of a label held by the label holding unit from the back side of the label towards the surface side in a mountain-shape forming a folded portion having a first side face and a second side face with an apex portion as a border therebetween, and applying each outer end portion provided next to each base end portion of the first side face and the second side face of the folded portion via a bent portion to an article; wherein the label holding unit is configured with a pair of divided body which attracts and holds the label; and the label application device further comprising: the folding and applying unit, wherein the divided bodies are relatively approaching and separating the other and when approaching the other, a portion of the label is folded by pressing such that the bent portions of the label at each end surface opposing each of the divided body forming the folded portion; and a movement control unit controlling the movement of the divided bodies of the folding unit, wherein, at attracting and holding of the label supplied from the label supplying unit, the movement control unit defines the position of the divided bodies when attracting and holding the label supplied from the label supplying unit, at a separation position where the each divided body are separated from the other enabling attracting and holding the outer end portions of the label by the each divided body, and from the separation position to a folded portion forming position where the divided bodies approach the other forming the folded portion.

Accordingly, when applying labels, first, movement control unit defines the each divided body at the separation position in advance by the folding and applying unit, enabling attracting and holding the outer end portion of the label by the each divided body. In this state, the label is supplied from the label supplying unit and a pair of divided bodies attracts and holds the label at the outer end portions of the label. Next, the movement control unit defines the position of the pair of divided bodies approaching the other from the separation position to the folded portion forming position by the folding and applying unit. At this approach, the bent portions of the label are pressed by the end surfaces opposing each divided body, and a portion of the label is folded forming the folded portion. Then, the label in this folded state, is applied to the article. Because of this, the applying operation can be performed extremely easily by the folding and applying unit protruding a portion of the label in a mountain-shape and automatically applying the label towards an article.

Particularly, the movement control unit, when attracting and holding the label, defines the divided bodies separated at the separation position. Therefore, compared to the case of defining the position by attracting and holding the label at joining position of the divided bodies abutting the other, and moving the divided bodies to the separation position then to the folded portion forming position by the divided bodies approaching, the operation process of the divided bodies is reduced, enabling to improve the work efficiency.

In addition, according to the setting manner of the folded portion forming position, it is possible to change the manner of label application, for example, the label application device forms a space between the first side face and the second side face of the label forming the label as it were in an inverted V-shape and applies the label, or joins the first side face and the second side face of the label and applies the label, etc.

Then, if necessary, the separation position of the divided body is configured such that the position of which the end portion of the end surface of the divided body in contact with the label is in a corresponding position to the bent portion of the label. At approach of the divided bodies, as the end portions of the divided bodies are positioned at the bent portions of the label, it is possible to securely fold the label at the bent portions.

Furthermore, if necessary, the label application device configures the folded portion forming position at a position separated by a predetermined interval from the joining position where the divided bodies abut the other, and forms a space between the first side face and the second side face of the label. It is possible to apply the label providing a space between the first side face and the second side face of the label forming the label as it were in an inverted V-shape.

Still furthermore, if necessary, the label application device configures the folded portion forming position at a same position as the joining position where the divided bodies abut the other, and joins the first side face and the second side face of the label. It is possible to apply the label joining the first side face and the second side face of the label.

In addition, if necessary, the label application device is provided with an air blowing pipe, blowing the air from the back side of the label towards the each divided body, assisting the each divided body attracting and holding the label when the each divided body attracting and holding the label supplied from the label supplying unit. By the air blow from the air blowing pipe, it is possible to press the label to the each divided body such that the label can be securely attracted and held by the each divided bodies.

In this case, it is effective to form the air blowing pipe such that the air blowing range is directing towards the outer end portions of the label. In case the air is blown to the entire surface of the label, the middle portion of the label positioned between the each divided body is curved by the air, causing the outer end portions of the label to move and misalign relative to the divided bodies. If the outer end portions of the label are misaligned relative to the divided bodies, later when the each divided body approach the folded portion forming position, the pressing of the bent portions of the label by the each divided body will be insufficient such that folding of a portion of the label will not be performed smoothly, thereby causing trouble in forming the folded portion. However, in the present configuration, as the air blow from the air blowing pipe is provided such that it is directed towards the outer end portions of the label, it prevents the middle portion of the label from curving by the air and the outer end portions of the label from moving and misaligning relative to the divided bodies, thereby securely attracting and holding the outer end portions by the each divided bodies, performing folding of a portion of the label smoothly, and securely forming the folded portion.

In addition, if necessary, it is configured to blow the air from the air blowing pipe when moving the above-mentioned divided bodies from the separation position to the folded portion forming position.

Because of this, when the bent portions of the label are pressed at the opposing end surfaces of the divided bodies and a portion of the label is folded, the air is blown from the air blowing pipe such that the air blown from the air blowing pipe is directing towards the outer end portions of the label. But in the process of moving the second divided body from the separation position to the folded portion forming position, the air current from the air blowing pipe moderately acts upon the middle portion of the label preventing a portion of the label protruding from the surface side (the indication layer side) to the back side (the adhesive layer side) and bending in the opposite direction. Then a portion of the label is folded securely into a space formed between the first divided body and the second divided body, in other words, is securely folded from the back side (the adhesive layer side) to the surface side (the indication layer side), thereby securely forming the folded portion.

Furthermore, if necessary, the label application device is provided such that a label supplying direction of the label supplying unit and the approaching and separating directions of the divided bodies are perpendicular to the other. In case ae portion of the label is formed in a variant form, with the first side face and the second side face constricted inwardly such that a portion of the label is smaller in width, the rigidity is smaller accordingly. In this case, since the label supplying direction and the approaching and separating directions of the divided bodies are perpendicular to the other, it is possible to supply the label with the folding lines of the apex portion and the bent portions parallel to the label supplying direction, thereby preventing the label from flexing and curving at supply, enabling the label to be attracted and held securely to the label holding unit.

Still furthermore, as the label from the label supplying unit is supplied with the outer end portions contacting the each divided body previously positioned at the separating position, the outer end portions of the label are securely attracted and held to the divided bodies preventing failure in attracting and holding of the label.

In addition, if necessary, the folding and applying unit includes a transfer unit which transfers the label holding unit to the two positions, the attracting and holding position where the label holding unit attracts and holds the label, and the applying position where the attracted and held label is applied to the article.

### ADVANTAGEOUS EFFECTS OF INVENTION

According to the label application device of the present invention, the applying operation can be performed extremely easily by the folding and applying unit protruding a portion of the label in a mountain-shape and automatically applying the label towards the article. Particularly, as the movement control unit positions the divided body at the separation position when attracting and holding the label, as soon as the label is attracted and held by the divided bodies, the movement control unit moves the divided bodies to the folded portion forming position performing folding of the label. Therefore, compared to the case of defining the position by attracting and holding the label at joining position of the divided bodies abutting the other, and moving the divided bodies to the separation position then to the folded portion forming position by the divided bodies approaching, the operation process of the divided bodies is reduced, improving the work efficiency.

### BRIEF DESCRIPTION OF THE DRAWINGS

FIG. 1 is a perspective view showing the label application device related to the embodiment of the present invention.

FIG. 2 is a front view showing the operation of the label application device related to the embodiment of the present invention.

FIG. 3 is a front view showing the operation of the label application device related to the embodiment of the present invention.

FIG. 4 is a front view showing the operation of the label application device related to the embodiment of the present invention.

FIG. 5 is a front view showing the operation of the label application device related to the embodiment of the present invention.

FIG. 6 is a perspective view showing a substantial portion of the label application device related to the embodiment of the present invention.

FIG. 7 is an exploded perspective view showing a substantial portion of the label application device related to the embodiment of the present invention.

FIG. 8(a) is a diagram showing an example of a label used in the label application device related to the embodiment of the present invention.

FIG. 8(b) is a diagram showing an example of a label used in the label application device related to the embodiment of the present invention.

FIG. 8(c) is a diagram showing an example of a label used in the label application device related to the embodiment of the present invention.

FIG. 8(d) is a diagram showing an example of a label used in the label application device related to the embodiment of the present invention.

FIG. 9 is a diagram showing an example of the label used in the present invention.

### DESCRIPTION OF EMBODIMENTS

Hereinafter, a label application device according to the embodiment of the present invention is described in detail based on the attached figures.

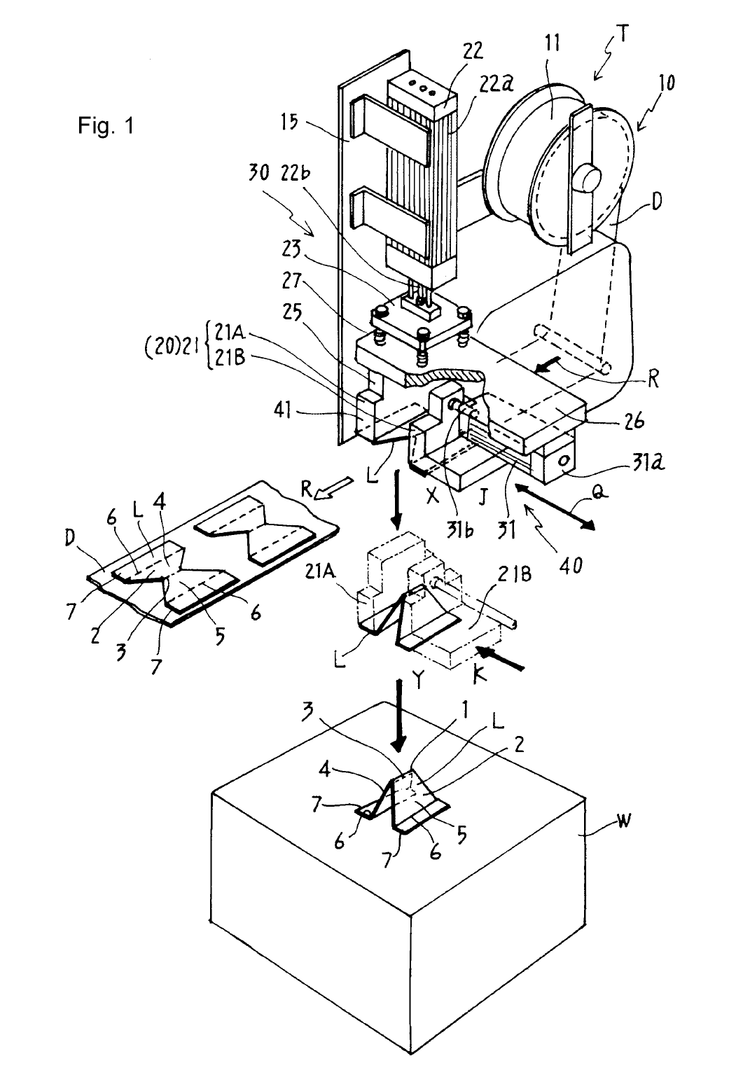

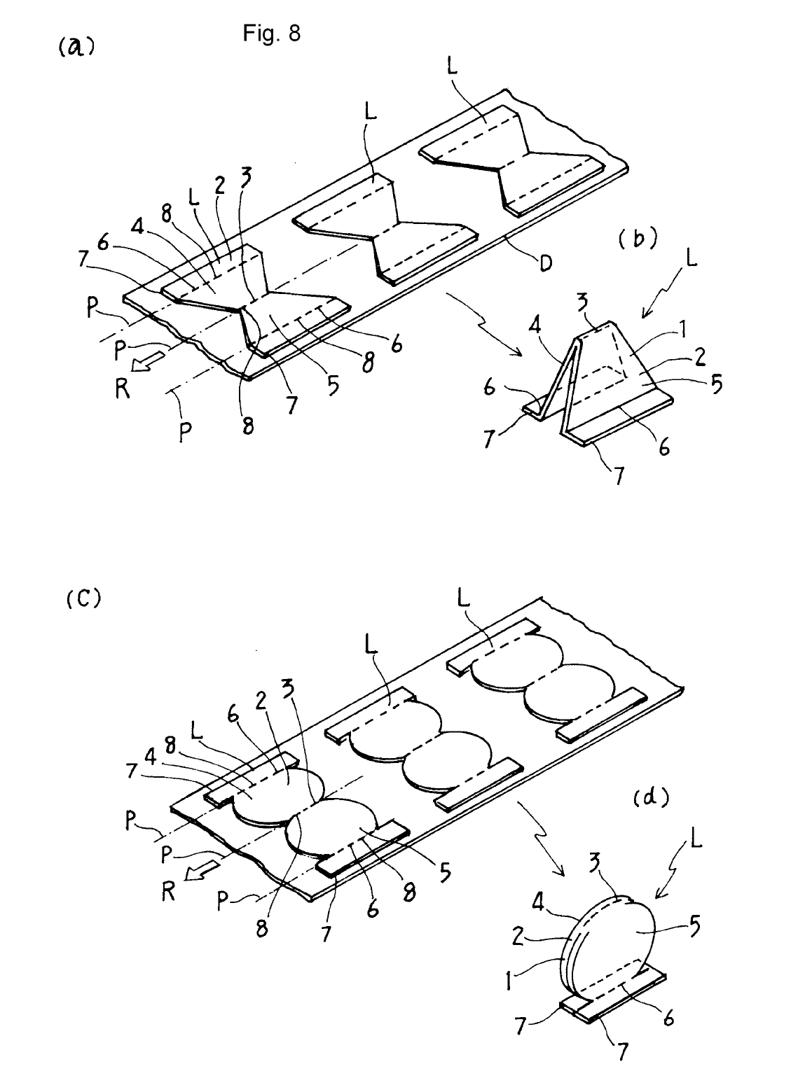

First, FIGS. 1 through 7 show the label application device T related to the embodiment of the present invention. The label L which is the object of the label application device T related to the embodiment, as shown in FIGS. 1, 8(a), 8(b), 8(c) and 8(d), is formed as a folded portion 1 with a portion 2 in the middle part of the label folded and protruded from the back side to the surface side in a mountain-shape and having a first side face 4 and a second side face 5 with an apex portion 3 as a border therebetween, and having each outer end portion 7 provided next to each base end portion of the first side face 4 and the second side face 5 of the folded portion 1 via a bent portion 6. Only the back sides of the outer end portions 7, or the entire back side are coated with an adhesive and, in a planar state, are temporally attached to the backing sheet D in a row. The label L is temporally attached to the backing sheet D with the folding lines P of the apex portion 3 and the bent portions 6 parallel to the longitudinal direction of the backing sheet D (the supplying direction R of the label L).

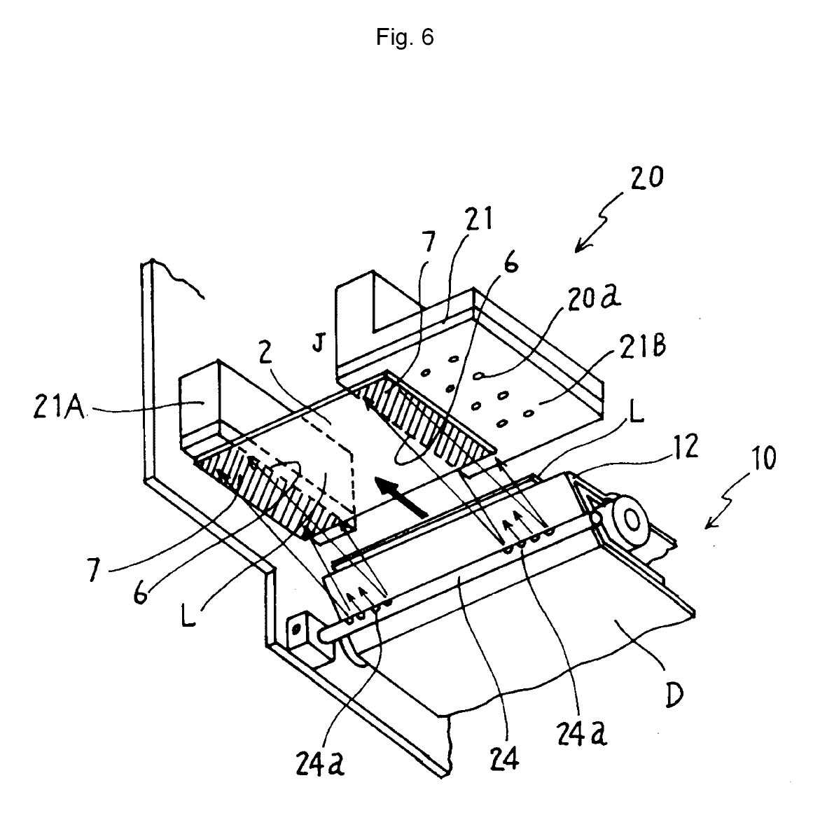

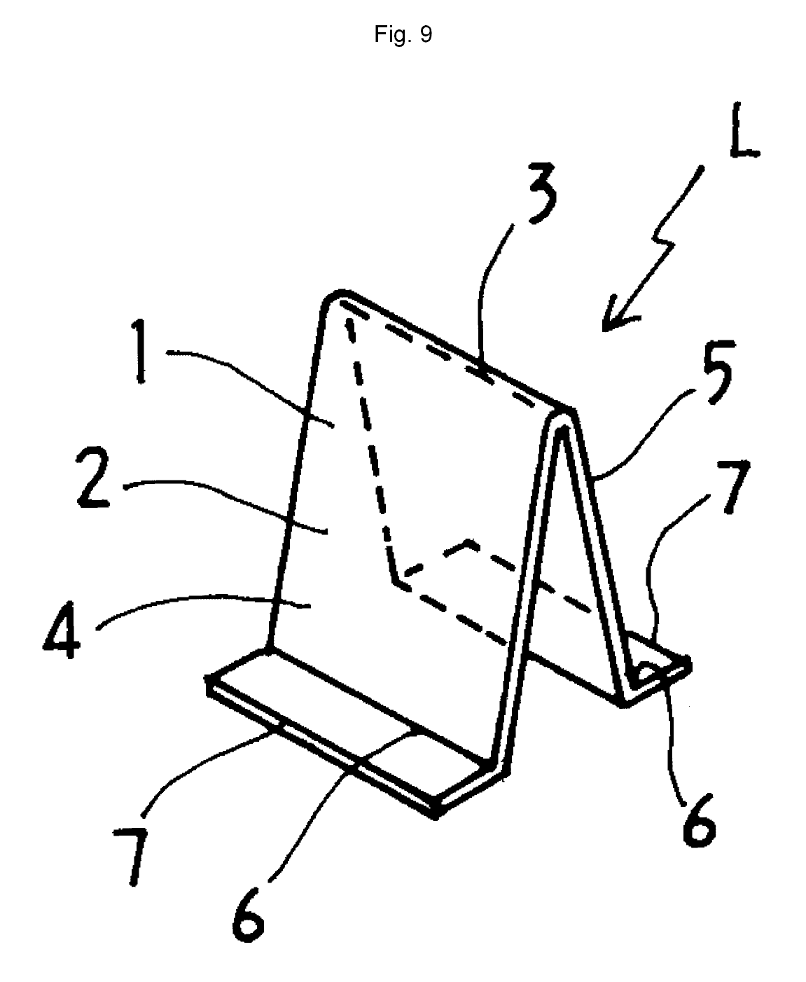

In addition, the label L which is the object of the label application device T related to the embodiment may be a rectangular-shaped label (FIGS. 6 and 9), or as shown in FIGS. 1, 8(a), 8(b), 8(c) and 8(d), a portion 2 in the middle part of the label may be formed in a variant form, mainly, with the first side face 4 and the second side face 5 constricted inwardly such that a portion 2 of the label is small in width. And various sorts of shapes may be employed.

At the folding lines P of the apex portion 3 and the bent portions 6, perforations 8 are formed. As the perforations 8 are formed, folding can be performed easily.

Then the label L, as shown in FIGS. 1, 8(a) and 8(b), is applied providing a space between the first side face 4 and the second side face 5 of the label L forming the label L as it were in an inverted V-shape, or as shown in FIGS. 8(c) and 8(d), is applied joining the first side face 4 and the second side face 5 of the label L.

The label application device T related to the embodiment of the present invention, as shown in FIG. 1, applies the label L to the article W conveyed along the predetermined conveyance direction by the conveyor not shown in the diagram.

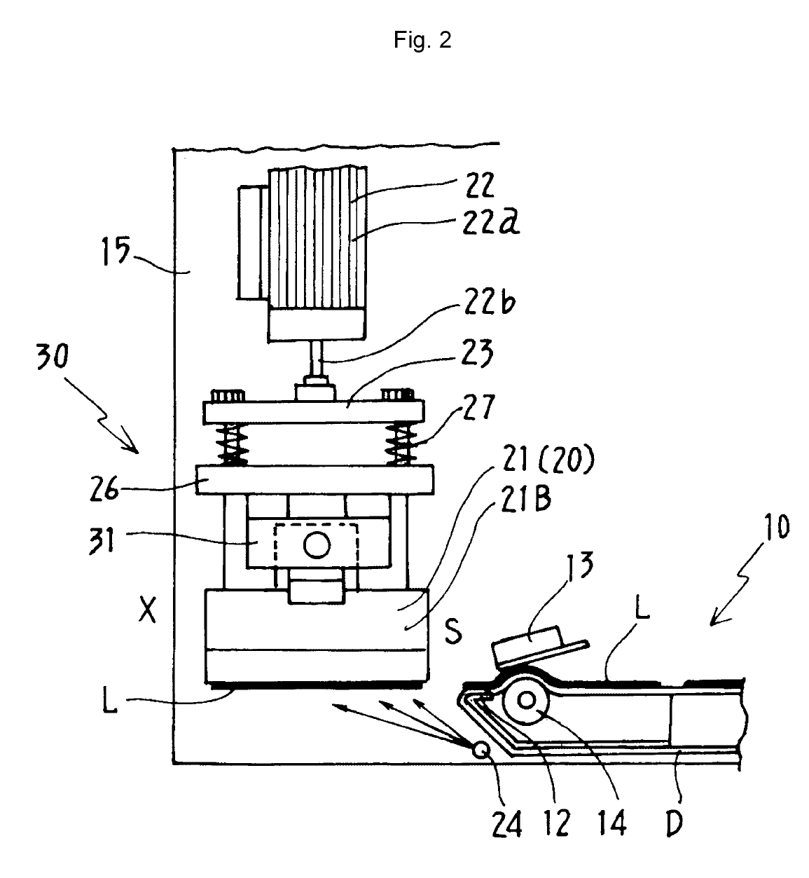

The label application device T, as shown in FIGS. 1 through 6, is provided with a label supplying unit 10. The label supplying unit 10 peels off the label L from the strip-shaped backing sheet D where the label L is temporally attached, and feeds out the label L. The label supplying unit 10 peels off the label L, which is supplied from the supply reel 11 to the conveyance route, from the strip-shaped backing sheet D by the peel-off board 12 and by the take-up reel which is not shown in the diagram, takes up the strip-shaped backing sheet D of which the label L is peeled off. The peel-off board 12, by folding back the strip-shaped backing sheet D conveyed through the conveyance route of the backing sheet D, peels off the label L, of which the rigidity is larger than that of the strip-shaped backing sheet D, from the strip-shaped backing sheet D, feeds out and supplies the label L. In FIG. 2, the reference number 13 is the thermal head for printing on the label L and the reference number 14 as the platen.

In addition, the label application device T is provided with a label holding unit 20 attracting and holding the label L supplied from the label supplying unit 10. The label holding unit 20 is provided with an attracting and holding board 21. The attracting and holding board 21 attracts and hold the surface side of the label L peeled off by the peel-off board 12. At the attracting and holding board 21, a plurality of small holes 20a (FIG. 6) attracting and holding the surface of the label L by air suction are provided. The attracting and holding board 21 is divided and formed by the line along the supplying direction R of the label L, in other words, the line parallel to the folding lines P of the apex portion 3 and the bent portions 6 of the label L, and formed and provided with a pair of divided bodies 21A and 21B able to approach and separate from the other, attracting and holding the label L. In other words, the label supplying direction R of the label supplying unit 10 and the approaching and separating direction Q of the pair of divided bodies 21A and 21B are perpendicular to the other.

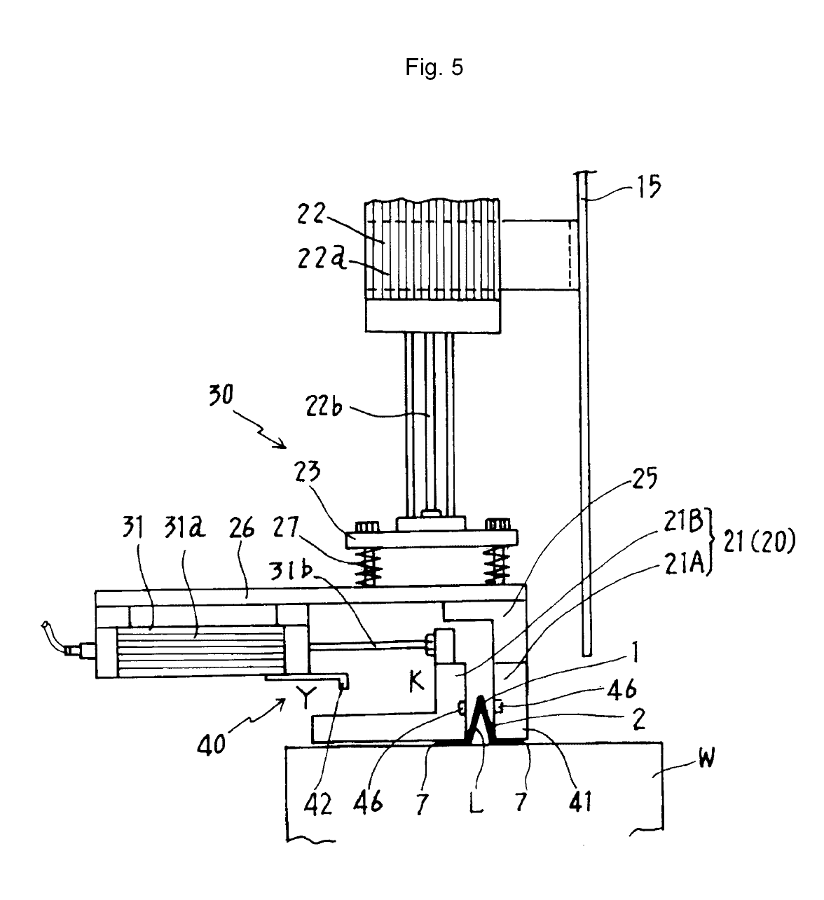

Furthermore, the label application device T is provided with a folding and applying unit 30. The folding and applying unit 30 is provided with an air cylinder unit 22, provided as a transfer unit transferring the attracting and holding board 21 of the label holding unit 20 to the two positions; the attracting and holding position X where the label attracting and holding board 21 of the label holding unit 20 attracting and holding the label L at the after-mentioned separation position J of the divided bodies 21A and 21B, and the application position Y where the label attracting and holding board 21 of the label holding unit 20 applying the attracted and held label L to the article W at the after-mentioned folded portion forming position K of the divided bodies 21A and 21B. In other words, by the air cylinder unit 22 comprising of a cylinder 22a and a piston 22b, the attracting and holding board 21 is transferred to the attracting and holding position X (FIGS. 1 through 4 and FIG. 6) at which the label L is attracted and held, and to the application position Y (FIG. 5) at which the label L is applied to the article W. The cylinder 22a of the air cylinder unit 22 is supported by a machine base 15, and a fixing board 23 supporting the attracting and holding board 21 is assembled at the end of the piston 22b.

Still furthermore, near the peel-off board 12, an air blowing pipe 24 assisting attracting and holding of the label L at the attracting and holding position X by the attracting and holding board 21 is provided. The air blowing pipe 24 blows the air from the air blowing nozzle towards the attracting and holding board 21 side from the back side of the label L peeled off from the peel-off board 12.

In detail, as shown in FIG. 6, the air blowing pipe 24, when attracting and holding the label L supplied from the label supplying unit 10 by the each divided body 21A and 21B, blows the air towards the each divided body 21A and 21B from the back side of the label L, assisting attracting and holding the label by the each divided body 21A and 21B. Then, the air blowing pipe 24 is provided with the air blowing nozzles 24a only on the right and the left sides such that an air blowing range is directing towards the outer end portions 7 of the label. The nozzles 24a are not provided at the portion corresponding to a portion 2 in the middle part of the label L, which is the portion between the bent portions 6.

Then, the folding and applying unit 30, at the attracting and holding position X of the attracting and holding board 21 of the attracting and holding unit 20, folds and protrudes a portion 2 of the label L held by the label holding unit 20 from the back side of the label towards the surface side in a mountain-shape forming the folded portion 1 having the first side face 4 and the second side face 5 with the apex portion 3 as a border therebetween, and applies each outer end portion 7 provided next to each base end portion of the first side face 4 and the second side face 5 of the folded portion 1 via the bent portion 6 to the article W. The folding and applying unit 30 is comprised of the attracting and holding board 21 having the above-mentioned divided bodies 21A and 21B.

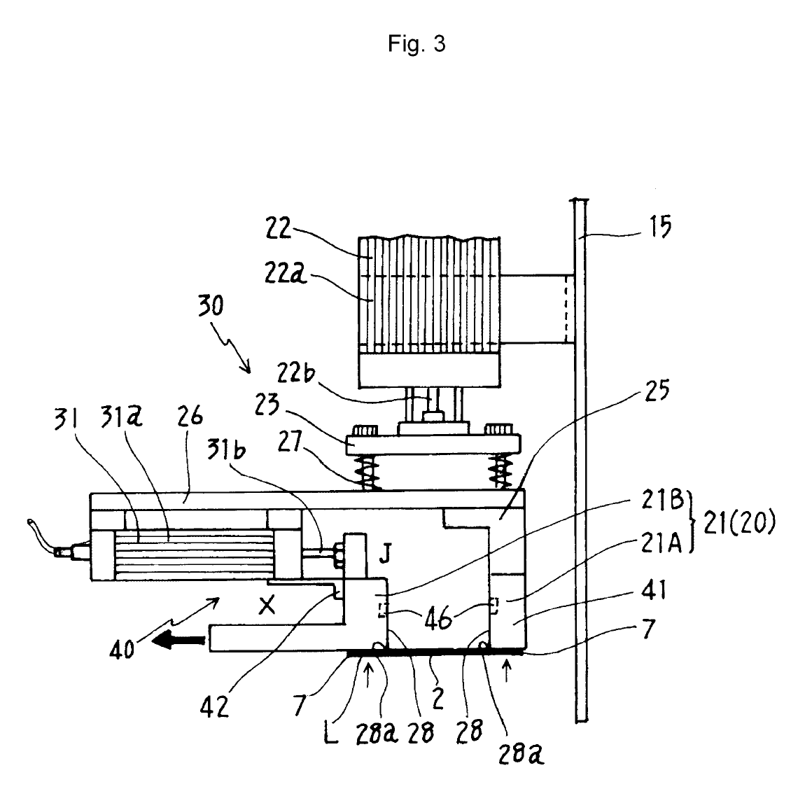

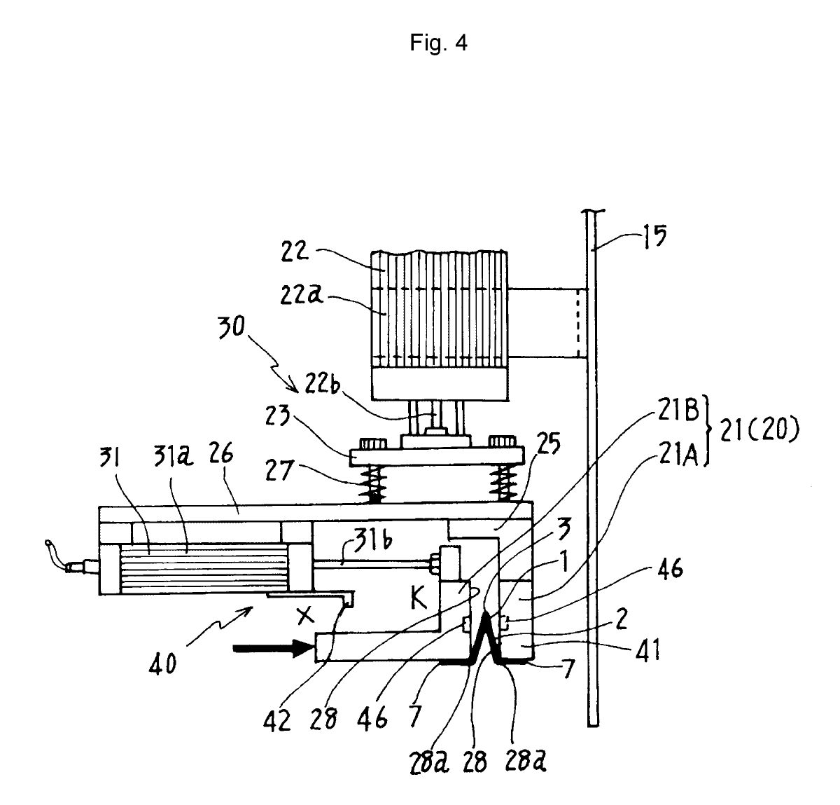

In detail, the first divided body 21A is supported against the base 26 via the supporting member 25. By the spring 27, the base 26 is biased towards the article W side and supported by the fixing board 23. The second divided body 21B is supported such that it is possible to be moved in the transferring direction Q perpendicular to the supplying direction R of the label L. And the folding and applying unit 30 is comprising of the air cylinder unit 31 as the folding unit, wherein the divided bodies 21A and 21B are relatively approaching and separating the other, and at approach, a portion 2 of the label L is folded by pressing such that the bent portions 6 of the label L at each end surface 28 (FIGS. 3 and 4) opposing each of the divided body 21A and 21B forming the folded portion 1. This air cylinder unit 31 performs approaching and separating of the second divided body 21B to and from the first divided body 21A, and is comprising of the cylinder 31a fixed to the base 26 and the piston 31b, where the second divided body 21B is assembled. This makes the directions, the supplying direction R of the label L of the label supplying unit 10 and the approaching and separating direction of the divided bodies 21A and 21B perpendicular.

Furthermore, the folding and applying unit 30 is provided with a movement control unit 40 controlling the movement of the divided bodies 21A and 21B of the folding unit. The movement control unit 40 positions the moving second divided body 21B, at the separation position J (FIGS. 1, 3 and 6) where the each divided body 21A and 21B are separated from the other when attracting and holding the label L supplied from the label supplying unit 10 enabling attracting and holding the outer end portions 7 of the label L by the each divided body 21A and 21B, and from the separation position J to the folded portion forming position K (FIGS. 4 and 5) where the divided bodies 21A and 21B approach the other forming the folded portion 1. The movement control unit 40 can position the moving second divided body 21B also at the joining position (not shown in the diagram) where the divided bodies 21A and 21B abut the other.

The separation position J of the divided bodies 21A and 21B is configured to be at a position where the end portion 28a of the end surface 28 of the divided bodies 21A and 21B contact the label L corresponding to the bent portions 6 of the label L. The first divided body 21A is prepared with a length corresponding to the length of the outer end portion 7 of the label L, and with the end portion 28a of the end surface 28 contacting the label L positioned at the position of the bent portion 6 of the label L supplied from the label supplying unit 10. The second divided body 21B is positioned at the separation position J such that the end portion 28a is positioned to be at the bent portion 6 of the label L. At the separation position J, a space is formed between the first and the second divided bodies 21A and 21B where a portion 2 of the label L protruding from the back side towards the surface side can enter, and the first and the second divided bodies 21A and 21B attracts and holds both outer end portions 7 of the label L supplying direction R.

In case of applying the label L by providing a space between the first side face 4 and the second side face 5 of the label L forming the label as it were in an inverted V-shape, the folded portion forming position K is configured, as shown in FIGS. 1 and 8(b), at a position (FIG. 4) separated from the joining position by a predetermined interval and where the space between the first side face 4 and the second side face 5 of the label L is formed.

Whereas, as shown in FIG. 8(d), in case of applying the label L by joining the first side face 4 and the second side face 5 of the label L, the folded portion forming position K is configured at a position same as the joining position where the first side face 4 and the second side face 5 of the label L are joined.

The movement control unit 40, specifically, controls the stroke of the air cylinder unit 31. At the joining position, the movement control unit 40 is provided with a positioning member 41 positioning the second divided body 21B by abutting the second divided body 21B to the first divided body 21A. The positioning member 41 is comprised of the first divided body 21A.

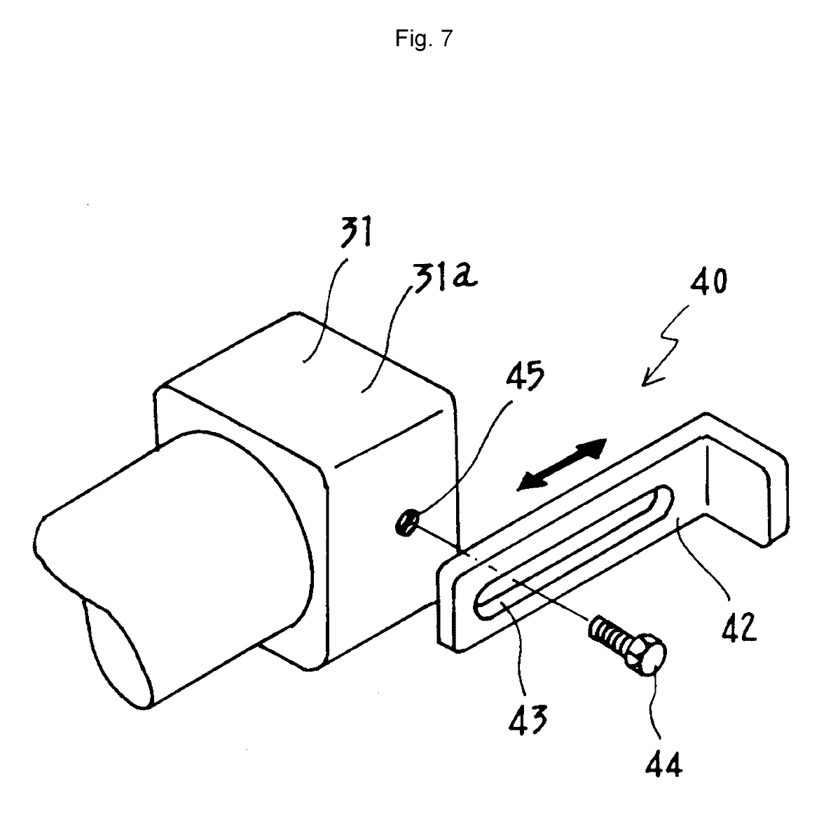

In addition, at the separation position J, the movement control unit 40 is provided with an abutting member 42 abutting against the downstream side surface of the second divided body 21B, and positioning this second divided body 21B to be at the bent portion 6 of the label L as mentioned-above. As shown in FIG. 7, on the abutting member 42, a long hole 43 is formed along the movement direction of the piston 31b of the air cylinder unit 31. By inserting the bolt 44 through this long hole 43 and screwing-in this bolt 44 to the internal thread 45 provided at the cylinder 31a, the abutting member 42 is fixed to the cylinder 31a. By making the inserting position of the bolt 44 to the long hole 43 variable, the abutting position of the second divided body 21B to the abutting member 42 is made variable, enabling adjustment of the second divided body 21B stop position.

The movement control unit 40 positions the second divided body 21B at the folded portion forming position K. On the divided bodies 21A and 21B, provided are position detection sensors 46, such as optical sensors, etc., detecting the second divided body 21B reaching the folded portion forming position K from the separation position J. The movement control unit 40 is provided with a control unit (not shown in the diagram) which stops the air supply to the cylinder 31a and stops the second divided body 21B at the folded portion forming position K when the position detection sensor 46 detects the second divided body 21B reaching the folded portion forming position K from the separation position J.

In this case, as shown in FIGS. 4 and 5, if applying the label L by providing a space between the first side face 4 and the second side face 5 of the label L forming the label as it were in an inverted V-shape, the position detection sensor 46 detecting the second divided body 21B reaching the separated position from the joining position S by a predetermined interval.

Whereas as shown in FIG. 8(d), in case of applying the label L by joining the first side face 4 and the second side face 5 of the label L, the position detection sensor 46 detects the second divided body 21B reaching the joining position.

Therefore, the application of the label L by the label application device T related to the embodiment will be as follows. Here, as shown in FIGS. 1 and 8(b), the label application by providing a space between the first side face 4 and the second side face 5 of the label L forming the label as it were in an inverted V-shape will be explained.

First, as shown in FIGS. 1, 3 and 6, by the air cylinder unit 31, the second divided body 21B of the attracting and holding board 21 is positioned at the separation position J, and the divided bodies 21A and 21B are separated from the other. Also, by the air cylinder unit 22, this attracting and holding board 21 is positioned at the attracting and holding position X. In this state, when the label L is conveyed by the label supplying unit 10, and the backing sheet D is peeled off by the peel-off board 12, the pair of divided bodies 21A and 21B of the attracting and holding board 21 attracts and hold the label L by the outer end portions 7.

In this case, if the label L is formed such that a portion 2 in the middle of the label is formed in a variant form with the first side face 4 and the second side face 5 constricted inwardly thereby smaller in width, the rigidity of the label L is smaller accordingly. However, as the label L is fed out with the folding lines P of the apex portion 3 and the bent portions 6 parallel to the longitudinal direction (the supplying direction R of the label L) of the backing sheet D, the label is prevented from flexing and curving at supply, and attracting and holding of the label is performed securely.

In addition, in this case, as shown in FIGS. 2 and 6, when attracting and holding the label L supplied from the label supplying unit 10 by the each divided body 21A and 21B, the air blowing nozzle 24 blows the air from the back side of the label L towards the each divided body 21A and 21B assisting the attracting and holding of the label L by the each divided body 21A and 21B. The air blowing pipe 24 is provided such that an air blowing range is directing towards the outer end portions 7 of the label L. Therefore, in case the air is blown to the entire surface of the label L, the middle portion of the label L positioned between the each divided body 21A and 21B is curved by the air, causing the outer end portions 7 of the label to move and misalign relative to the divided bodies 21A and 21B. However, in the present embodiment, as the air blow from the air blowing pipe 24 is directed towards the outer end portions 7 of the label L, it prevents the middle portion of the label L from curving by the air and the outer end portions 7 of the label L from moving and misaligning relative to the divided bodies 21A and 21B, thereby securely attracting and holding the outer end portions 7 by the each divided bodies 21A and 21B.

Next, as shown in FIGS. 1 and 4, the air cylinder unit 31 is operated, and the second divided body is moved from the separation position J to the folded portion forming position K. Thereby the first divided body 21A and the second divided body 21B each attracts and holds the respective outer end portions at the supplying direction R of the label L, and in the direction of the first side face 4 and the second side face 5 approaching the other, presses the bent portions 6 of the first side face 4 and the second side 5 forming the folded portion 1. The folded portion 1 is formed by a portion 2 of the label L protruding from the back side (the adhesive layer side) to the surface side (the indication layer side) in the space between the first divided body 21A and the second divided body 21B. In this case, the air from the air blowing pipe 24 is directed towards the outer end portions 7 of the label L. However, during the process of moving the second divided body 21B from the separation position J to the folded portion forming position K, the air current from the air blowing pipe 24 moderately acts upon the middle portion of the label L, preventing a portion 2 of the label L protruding from the surface side (the indication layer side) to the back side (the adhesive layer side). Specifically, by referring to FIGS. 4 and 5, a portion 2 of the label L is prevented from protruding and being folded in the opposite direction towards the article W.

Then, as the position detection sensor 46 detects the second divided body 21B reaching the folded portion forming position K from the separation position J, the air supply to the cylinder 31a stops, and the second divided body 21B is stopped at the folded portion forming position K.

Then, as shown in FIGS. 1 and 5, the air cylinder unit 22 operates and moves the attracting and holding board 21 from the attracting and holding position X to the application position Y, thereby applying the attracted and held label L to the article W. In this case, both outer end portion 7 of the folded portion 1 at a portion 2 of the label L protruded in a mountain-shape, are pressed to the article W by the first divided body 21A and the second divided body 21B securely applying the label L to the article W. After applying the label L, the attracting and holding board 21 is returned to the attracting and holding position X by the air cylinder unit 22, and the divided body 21B of the attracting and holding board 21 is positioned at the separation position J by the air cylinder unit 31.

Next, regarding the label application device T related to the embodiment, as shown in FIG. 8(d), the case of applying the label L by joining the first side face 4 and the second side face 5 will be explained. In this case, the label application device T is operated almost in the same way as the above-mentioned, but unlike the above-mentioned, the movement control unit 40 positions the folded portion forming position K at the same position as the joining position. Therefore, when the attracting and holding board 21 attracts and holds the label L at the attracting and holding position X, and moves the second divided body 21B from the separation position J to the folded portion forming position K, since the folded portion forming position K is at the same position as the joining position, the second divided body 21B is abutted to the first divided body 21A. Thereby the end surfaces 28 opposing each of the first divided body 21A and the second divided body 21B abut and press the surfaces of the first side face 4 and the second side face 5, which are at a portion 2 of the label L, forming the folded portion 1. The other operations and effects are the same as the above-mentioned.

Also, even if it is a label L provided without the perforations 8 and fold lines, etc., the present invention may be applied. Furthermore, in the label application device of the above-mentioned embodiment, the strokes of the air cylinder unit 31 controlled by the movement control unit 40 of the air cylinder unit 31 is made to mechanically stop the second divided body 21B by the first divided body 21A and the abutting member 42, as the positioning members 41. However, it is not necessarily limited by the disclosure herein, but like the case positioning the second divided body 21B at the folded portion forming portion K, the air cylinder unit 31 may be controlled to stop by position detection using the position detection sensor, and appropriate modifications may be made. In addition, not only limited to the position detection sensor, but for example, the air cylinder unit 31 may be controlled by time-control using a timer. Furthermore, instead of the air cylinder unit 31, it may be configured, for example, by using an actuator operating the piston 31b by the rack and pinion mechanism, or an actuator moving the piston 31b by an electric motor, and with appropriate modifications.

Furthermore, in the above-mentioned embodiment, although it is described that the label application device pressing and applying the label L to the article W by the air cylinder unit 22 moving the attracting and holding board 21 to the application position Y from the attracting and holding position X, it is not only limited to this. It is needless to mention that the present invention may also be applicable to a label application device with a label application method (the air-jet method) applying the label L by blowing the label L towards the article W.

Still furthermore, the label L may be temporary applied with the folding lines P of the apex portion 3 and the bent portions 6 perpendicular to the longitudinal direction (supplying direction R of the label L) of the backing sheet D, such that the supplying direction R of the label L from the label supplying unit 10 and the approaching and separating direction Q of the divided bodies 21A and 21B are in the same direction. However, to securely attract and hold the outer end portions 7 of the label L by the divided bodies 21A and 21B, the above-mentioned embodiment is preferable.

### CITATION LIST

Patent Literature 1: Registered Japanese Utility Model Publication No. 3073917

### REFERENCE SIGNS LIST

T label application device
L label
W article
1 folded portion
2 a portion
3 apex portion
4 first side face
5 second side face
6 bent portion
7 outer end portion
D strip-shape backing sheet
R supplying direction of label
P folding line of apex portion and bent portion
10 label supplying unit
11 supplying reel
12 peel-off board
20 label holding unit
21 attracting and holding board
21A first divided body
21B second divided body 22 air cylinder unit (transfer unit)
X attracting and holding position
Y applying position
24 air blowing pipe
24a blowing nozzle
28 end surface
28a end portion
30 folding and applying unit
31 air cylinder unit (folding unit)
Q transferring direction
J separation position
K folded portion forming position
40 movement control unit
41 positioning member
42 abutting member
43 long hole
44 bolt
45 internal thread
46 position detection sensor

1. A label application device applying a label supplied from a label supplying unit comprising:
a label holding unit attracting and holding a label supplied from the label supplying unit; and
a folding and applying unit folding and protruding a portion of a label held by the label holding unit from the back side of the label towards the surface side in a mountain-shape forming a folded portion having a first side face and a second side face with an apex portion as a border therebetween, and applying each outer end portion provided next to each base end portion of the first side face and the second side face of the folded portion via a bent portion to an article; wherein
the label holding unit is configured with a pair of divided body which attracts and holds the label; and the folding and applying unit comprising:
the folding unit, wherein the divided bodies are relatively approaching to and separating from the other, and when approaching the other, a portion of the label is folded by pressing such that the bent portions of the label at each end surface opposing each of the divided body forming the folded portion; and
a movement control unit controlling the movement of the divided bodies of the folding unit, wherein
the movement control unit defines the position of the divided bodies when attracting and holding the label supplied from the label supplying unit, at a separation position where each divided body are separated from the other enabling attracting and holding the outer end portions of the label by the each divided body, and from the separation position to a folded portion forming position where the divided bodies approach the other forming the folded portion.

2. The label application device according to claim 1, wherein the separation position of the divided body is the position of which the end portion of the end surface of the divided body in contact with the label is in a corresponding position to the bent portion of the label.

3. The label application device according to claim 1, wherein the label application device configures the folded portion forming position at a position separated by a predetermined interval from the joining position where the divided bodies abut the other, and forms a space between the first side face and the second side face of the label.

4. The label application device according to claim 1, wherein the label application device configures the folded portion forming position at the joining position where the divided bodies abut the other, and joins the first side face and the second side face of the label.

5. The label application device according to claim 1 includes an air blowing pipe, blowing the air from the back side of the label towards the each divided body, assisting the each divided body attracting and holding the label when the each divided body attracting and holding the label supplied from the label supplying unit.

6. The label application device according to claim 5, wherein the air blowing pipe is formed such that an air blowing range is directing towards an outer end portion of the label.

7. The label application device according to claim 1, wherein the air is blown from the air blowing pipe when the divided bodies are moved from a separation position to a folded portion forming position.

8. The label application device according to claim 1, wherein a label supplying direction of the label supplying unit and the approaching and separating directions of the divided bodies are perpendicular.

9. The label application device according to claim 1, wherein the folding and applying unit includes a transfer unit which transfers the label holding unit to the two positions which are an attracting and holding position where the label holding unit attracts and holds the label, and an applying position where the attracted and held label is applied to the article.
